(19) United States
(12) Patent Application Publication
(10) Pub. No.: US 2010/0192578 A1
(43) Pub. Date: Aug. 5, 2010

(54) SYSTEM AND METHOD FOR SUPPRESSING COMBUSTION INSTABILITY IN A TURBOMACHINE

(75) Inventors: Kapil Kumar Singh, Rexford, NY (US); Fei Han, Clifton Park, NY (US); Keith Robert McManus, Clifton Park, NY (US); Shivakumar Srinivasan, Greer, SC (US); Kwanwoo Kim, Greer, SC (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/363,018

(22) Filed: Jan. 30, 2009

(51) Int. Cl. F02C 1/00

(52) U.S. Cl. 60/737; 60/748

(57) ABSTRACT

A system for suppressing combustion instability in a turbomachine includes at least one combustion chamber operatively connected to the turbomachine, and at least one pre-mixer mounted to the at least one combustion chamber. The at least one pre-mixer is configured to receive an amount of fuel and an amount of air that is combined and discharged into the at least one combustion chamber. In addition, the turbomachine includes a combustion instability suppression system operatively associated with the at least one pre-mixer. The combustion instability suppression system is configured to create a combustion asymmetry. The combustion asymmetry facilitates combustion instability suppression in the turbomachine.

### BACKGROUND OF THE INVENTION

The subject matter disclosed herein relates to the art of turbomachines and, more particularly, to a system and method for suppressing combustion instability/dynamics in a turbomachine.

Combustion instability/dynamics is a phenomenon in turbomachines utilizing lean pre-mixed combustion. Depending on the nature of excitation of combustion chamber modes combustion instability can be low/high frequency. A low frequency combustion dynamics field is caused by excitation of axial modes, whereas a high frequency dynamic field is generally caused by the excitation of radial and azimuthal modes of the combustion chambers by the swirling flames and is commonly referred to as screech. The dynamic field created includes a combustion field component and an acoustic component that pass along a combustor during combustion. Under certain operating conditions, the combustion component and the acoustic component couple to create a high and/or low frequency dynamic field that has a negative impact on various turbomachine components with a potential for hardware damage. The dynamic field passing from the combustor may excite modes of downstream turbomachine components as can lead to catastrophic damage.

To address this problem, turbomachines are operated at less than optimum levels, i.e., certain operating conditions are avoided in order to avoid circumstances that are conducive to combustion instability. While effective at suppressing combustion instability, avoiding these operating conditions restricts the overall operating envelope of the turbomachine.

Another approach to the problem of combustion instability is to modify combustor input conditions. More specifically, fluctuations in the fuel-air ratio are known to cause combustion dynamics that lead to combustion instability. Creating perturbations in the fuel-air mixture by changing fuel flow rate can disengage the combustion field from the acoustic field to suppress combustion instability. While both of the above approaches are effective at suppressing combustion instability, avoiding various operating conditions restricts an overall operating envelope of the turbomachine while manipulating the fuel-air ratio requires a complex control scheme, and may lead to less than efficient combustion.

### BRIEF DESCRIPTION OF THE INVENTION

According to one aspect of the invention, a system for suppressing combustion instability in a turbomachine includes at least one combustor having a combustion chamber operatively connected to the turbomachine, and at least one pre-mixer mounted to the combustion chamber. The at least one pre-mixer is configured to receive an amount of fuel and an amount of air that is combined and discharged into the combustion chamber. In addition, the turbomachine includes a combustion instability suppression system operatively associated with the at least one pre-mixer. The combustion instability suppression system is configured to create a combustion asymmetry. The combustion asymmetry facilitates combustion instability suppression in the turbomachine.

According to another aspect of the invention, a method of suppressing combustion instability in a turbomachine includes directing a fuel-air mixture through at least one pre-mixer into at least one combustion chamber, and forming a combustion mixture asymmetry in the turbomachine. The combustion asymmetry suppresses combustion instability in the turbomachine.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional side view of a turbomachine including a system for suppressing combustion instability in accordance with exemplary embodiments of the invention;

FIG. 2 is a cross-sectional view of a combustor portion of the turbomachine of FIG. 1;

FIG. 3 is a schematic, cross-sectional view of a combustor portion of a turbomachine constructed in accordance with exemplary embodiments of the invention;

FIG. 4 is a schematic, cross-sectional view of a plurality of combustors constructed in accordance with exemplary embodiments of the invention;

FIG. 5 is a perspective view of a combustor constructed in accordance with exemplary embodiments of the invention; and

FIG. 6 is a schematic, cross-sectional view of a combustor nozzle in accordance with exemplary embodiments of the invention.

The detailed description explains embodiments of the invention, together with advantages and features, by way of example with reference to the drawings.

### DETAILED DESCRIPTION OF THE INVENTION

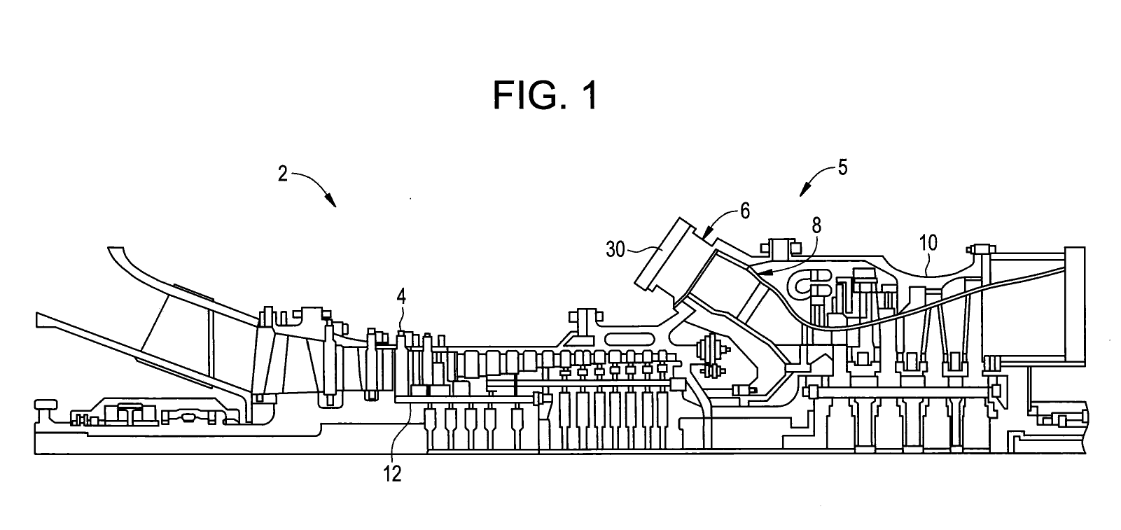

With initial reference to FIG. 1, a turbomachine constructed in accordance with exemplary embodiments of the invention is generally indicated at 2. Turbomachine 2 includes a compressor 4 and a combustor assembly 5 having a plurality of combustors, one of which is indicated at 6. In the exemplary embodiment shown, combustor 6 is provided with a fuel nozzle or injector assembly housing 8. Turbomachine 2 also includes a turbine 10 and a common compressor/turbine shaft 12. In one embodiment, turbomachine 2 is a PG9371 9FBA Heavy Duty Gas Turbine Engine, commercially available from General Electric Company, Greenville, S.C. Notably, the present invention is not limited to any one particular engine and may be used in connection with other gas turbine engines.

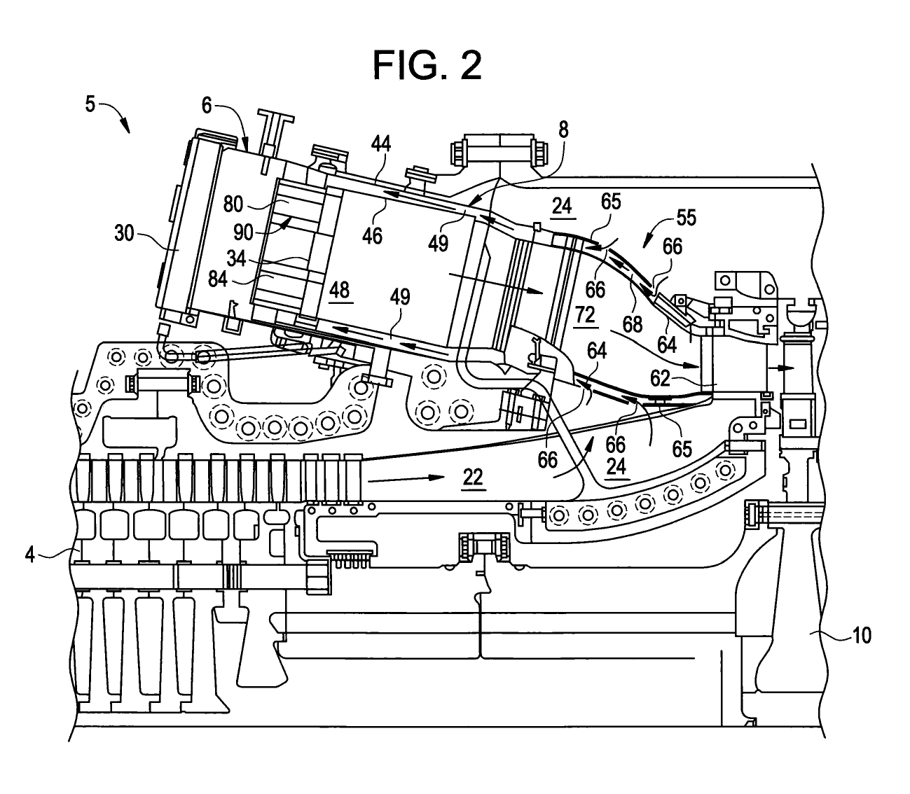

As best shown in FIG. 2, combustor 6 is coupled in flow communication with compressor 4 and turbine 10. Compressor 4 includes a diffuser 22 and a compressor discharge plenum 24 that are coupled in flow communication with each other. Combustor 6 also includes an end cover 30 positioned at a first end thereof, and a cap member 34. Combustor 6 further includes a combustor casing 44 and a combustor liner 46. As shown, combustor liner 46 is positioned radially inward from combustor casing 44 so as to define a combustion chamber 48. An annular combustion chamber cooling passage 49 is defined between combustor casing 44 and combustor liner 46. A transition piece 55 couples combustor 6 to turbine 10. Transition piece 55 channels combustion gases generated in combustion chamber 48 downstream towards a first stage turbine nozzle 62. Towards that end, transition piece 55 includes an inner wall 64 and an outer wall 65. Outer wall 65 includes a plurality of openings 66 that lead to an annular passage 68 defined between inner wall 64 and outer wall 65. Inner wall 64 defines a guide cavity 72 that extends between combustion chamber 48 and turbine 10.

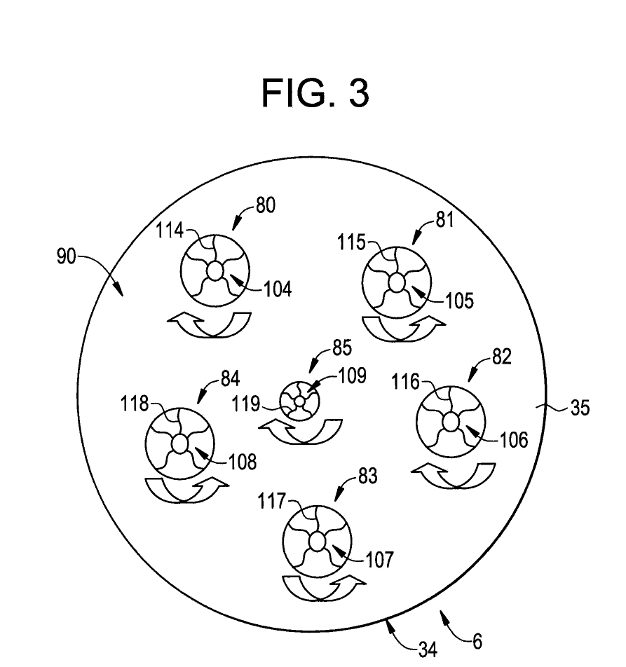

As will be discussed more fully below, combustor 6 includes a plurality of pre-mixers or injection nozzle assemblies 80-85 (see also FIG. 3) that direct a combustible mixture into combustion chamber 48. More specifically, during operation, air flows through compressor 4 and compressed air is supplied to combustor 6. Fuel is mixed with the compressed air in injection nozzle assemblies 80-85 to form a combustible mixture. The combustible mixture is discharged from injection nozzle assemblies 80-85 into combustion chamber 48 and ignited to form combustion gases. The combustion gases are then channeled to turbine 10. Turbine 10 converts thermal energy from the combustion gases to mechanical rotational energy that is employed to drive shaft 12.

More specifically, turbine 10 drives compressor 4 via shaft 12 (shown in FIG. 1). As compressor 4 rotates, compressed air is discharged into diffuser 22 as indicated by associated arrows. In the exemplary embodiment, a majority of the compressed air discharged from compressor 4 is channeled through compressor discharge plenum 24 towards combustor 6. Any remaining compressed air is channeled for use in cooling engine components. Compressed air within discharge plenum 24 is channeled into transition piece 55 via outer wall openings 66 and into annular passage 68. Air is then channeled from annular passage 68 through annular combustion chamber cooling passage 49 and to injection nozzle assemblies 80-85. The fuel and air are mixed to form the combustible mixture that is ignited creating combustion gases within combustion chamber 48. Combustor casing 44 facilitates shielding combustion chamber 48 and its associated combustion processes from the outside environment such as, for example, surrounding turbine components. The combustion gases are channeled from combustion chamber 48 through guide cavity 72 and towards first stage turbine nozzle 62. The hot gases impacting first stage turbine nozzle 62 create a rotational force that ultimately produces work from turbomachine 2.

At this point it should be understood that the above-described construction is presented for a more complete understanding of exemplary embodiments of the invention, which is directed to a combustion instability suppression system 90. In a manner that will become more fully apparent below, combustion instability suppression system 90 is configured to create an asymmetry in at least one of the combustors associated with turbomachine 2. In accordance with one exemplary embodiment, combustion instability suppression system 90 creates an asymmetry within combustion chamber 48 by varying exit geometry of the combustible mixture from each injection nozzle assembly 80-85.

As best shown in FIG. 3, each injection nozzle assembly 80-85 includes a corresponding exit member 104-109 having an associated directional component 114-119. The combustible mixture exiting each injection nozzle assembly 80-85 passes over the associated directional component 114-119 prior to entering combustion chamber 48. In this manner, a swirling or rotation is imparted to the combustible mixture passing from each nozzle 80-85. By arranging the nozzles 80-85 in various orientations such that, for example, directional component 114 of nozzle 80 imparts a swirling or rotation opposite to that of directional component 115 of nozzle 81, an interference is created. The interference de-couples the combustion field component from the acoustic component of the dynamic field to minimize any combustion instability within combustor 48.

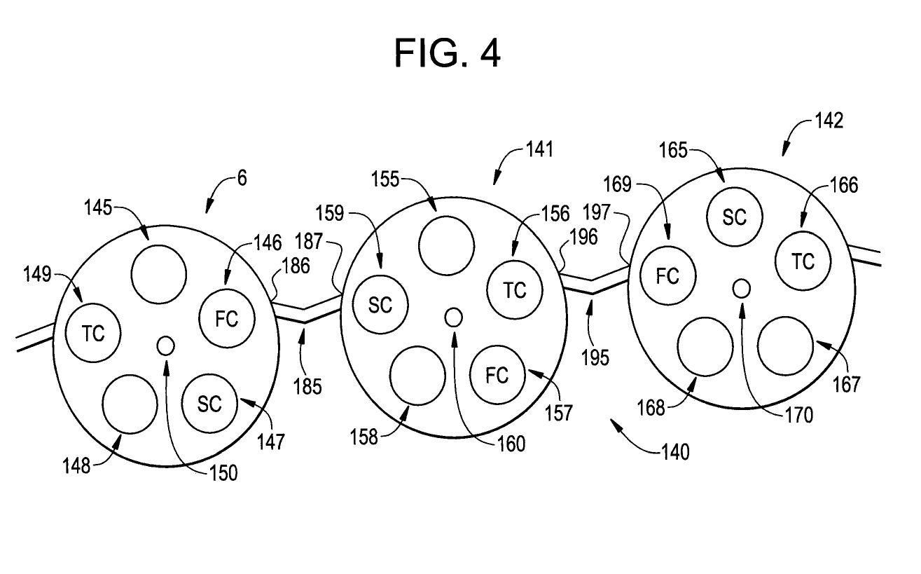

Reference will now be made to FIG. 4 in describing a combustion instability suppression system 140 constructed in accordance with another exemplary embodiment of the present invention. In the exemplary embodiment shown, turbomachine 2 includes a plurality of combustors arranged in a can-annular array. More specifically, turbomachine 2 includes at least the first combustor 6 having combustion chamber 48, a second combustor 141 having a combustion chamber (not separately labeled), and a third combustor 142 having a combustion chamber (also not separately labeled). In addition to the three combustors illustrated, turbomachine 2 includes a plurality of additional combustors, which may range in number from, for example 8 up to, for example 12. Combustor 6 includes a plurality of pre-mixers or injection nozzle assemblies 145-150. Each nozzle assembly 145-150 is configured to discharge a combustible mixture having particular properties. That is, for example, injection nozzle assembly 146 will emit a combustible mixture having a first configuration, injection nozzle assembly 147 will emit a combustible mixture having a second configuration and, injection nozzle assembly 149 will emit a combustible mixture having a third configuration. Each configuration can, for example, constitute a particular air fuel mixture, a combustible mixture including a particular diluents and the like. Similarly, combustor 141 includes a plurality of pre-mixers or injection nozzle assemblies 155-160, each being constructed to discharge a combustible mixture having a particular configuration. Likewise, combustor 142 includes a plurality of pre-mixers or injection nozzle assemblies 165-170 each of which is also configured to emit a combustible mixture having a particular configuration.

In the exemplary embodiment shown, combustor 6 is linked to combustor 141 via a cross-fire tube or conduit 185 having a first end portion 186 and a second end portion 187. More specifically, first end portion 186 is fluidly connected to combustor 6 while second end portion 187 is fluidly connected to second combustor 141. Similarly, second combustor 141 is fluidly linked to third combustor 142 via a cross-fire tube or conduit 195 having a first end portion 196 that extends to a second end portion 197. First end portion 196 is fluidly linked to combustor 141 while second end portion 197 is fluidly linked to combustor 142. With this arrangement, when the combustible mixture within, for example, combustor 6 is ignited, an associated flame front travels through conduits 185 and 195 igniting the combustible mixture in adjacent combustors 141 and 142.

In further accordance with the exemplary embodiment shown, the particular orientation of injection nozzle assemblies within each combustor 6, 141, and 142 is arranged with particularity in order to create a combustion asymmetry between the combustors. More specifically, injection nozzle assembly 146 in combustor 6 is configured to emit the combustible mixture with a first configuration and is positioned adjacent to first end portion 186 of conduit 185. Conversely, injection nozzle assembly 159 is configured to emit a fuel air mixture at a second configuration, distinct from the first configuration, and is arranged adjacent second end portion 187 of conduit 185. With this arrangement, combustion instability suppression system 140 creates an asymmetry between combustors 6 and 141. By creating an asymmetry between combustors 6 and 141, the combustion field component is de-coupled from the acoustic component of the dynamic field to suppress combustion instability generated by turbomachine 2.

In still further accordance with the exemplary embodiment shown, combustion instability suppression system 140 creates an asymmetry between combustor 141 and combustor 142. More specifically, injection nozzle assembly 156 is configured to emit a combustible mixture having a third configuration and is arranged adjacent to first end portion 196 of conduit 195. Conversely, injection nozzle assembly 169 is configured to emit a combustible mixture having a first configuration and is arranged adjacent second end portion 197 of conduit 195. By arranging injection nozzle assemblies configured to emit a combustible mixture at different configurations at either end of conduit 195 combustion instability suppression system 140 creates an additional asymmetry between combustor 141 and 142 to de-couple the combustion field component from the acoustic component in order to further reduce combustion instability.

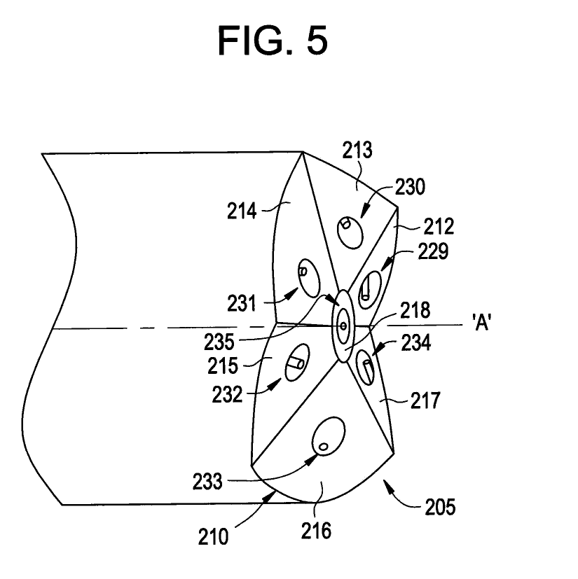

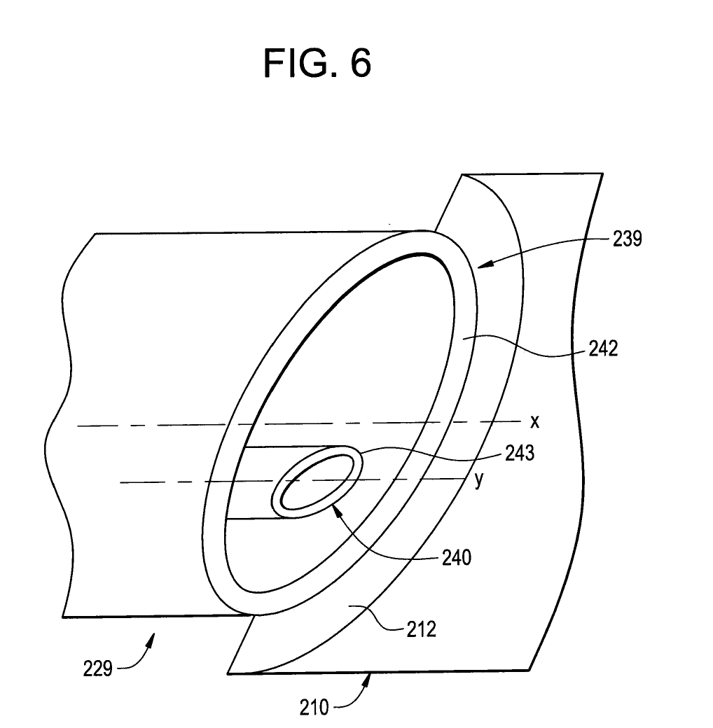

Reference will now be made to FIGS. 5 and 6 in describing a combustion instability suppression system 205 constructed in accordance with another exemplary embodiment of the invention. As shown, combustion instability suppression system 205 includes a cap member 210 having a first segment 212 arranged at a first angle relative to a center line axis A, a second segment 213 arranged at a second angle relative to center line axis A, a third segment 214 arranged at a third angle relative to center line axis A, a fourth segment 215 arranged at a fourth angle relative to center line axis A, a fifth segment 216 arranged at a fifth angle relative to center line axis A, a sixth segment 217 having a sixth angle relative to center line axis A and a seventh segment 218 arranged at a seventh angle relative to center line axis A.

As further shown in FIG. 5, a first injection nozzle assembly 229 is arranged within first segment 212, a second injection nozzle assembly 230 is arranged within second segment 213, a third injection nozzle assembly 231 is arranged within third segment 214, a fourth injection nozzle assembly 232 is arranged within fourth segment 215, a fifth injection nozzle assembly 233 is arranged within fifth segment 216, a sixth injection nozzle assembly 234 is arranged within sixth segment 217 and a seventh injection nozzle 235 is arranged within seventh segment 218.

In accordance with exemplary embodiments of the invention, seventh injection nozzle assembly 235 is configured to emit a combustible mixture along centerline axis A, while injection nozzle assemblies 229-234 are configured to emit the combustible mixture at an angle relative to one another and relative to centerline axis A. With this arrangement, combustion instability suppression system 205 creates an asymmetry within combustion chamber 48 in order to de-couple the combustion field component from the acoustic component to minimize or substantially eliminate any combustion instability.

As each injection nozzle assembly 229-235 is constructed substantially similarly, a detailed description will follow with respect to injection nozzle assembly 229 with an understanding that the remaining injection nozzle assemblies 230-235 include corresponding structure. As shown in FIG. 6, injection nozzle assembly 229 includes a first exit portion 239 having a first centerline axis X and a second exit portion 240 having a centerline axis Y. In accordance with the exemplary embodiment, second exit portion 240 is off-set relative to centerline axis X in order to facilitate a combustion asymmetry within combustion chamber 48. In addition, first exit portion 239 includes a first angle section 242 while second exit portion 240 includes a second angle section 243. Each angle section 242, 243 corresponds to the angle of first segment 212.

At this point it should be understood that exemplary embodiments of the invention create combustion asymmetries within turbomachine combustors and/or combustion asymmetries between adjacent combustors in order to de-couple the combustion field component from the acoustic component so as to suppress combustion instability within the turbomachine. By suppressing combustion instability at the source, i.e. the pre-mixers and combustors, instead of downstream thereof, the dynamic field is not given a chance to grow and propagate through various components of the turbomachine.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for suppressing combustion instability in a turbomachine comprising:
at least one combustor having a combustion chamber operatively connected to the turbomachine;
at least one pre-mixer mounted at the at least one combustion chamber, the at least one pre-mixer being configured to receive an amount of fuel and an amount of air that is combined and discharged into the at least one combustion chamber; and
a combustion instability suppression system operatively associated with the at least one pre-mixer, the combustion instability suppression system being configured to create a combustion asymmetry, the combustion asymmetry facilitating combustion instability suppression in the turbomachine.

2. The system according to claim 1, wherein the combustion instability suppression system creates the combustion asymmetry within the combustion chamber.

3. The system according to claim 1, wherein the at least one combustor comprises a plurality of combustors each having an associated combustion chamber, the combustion instability suppression system creating the combustion asymmetry between adjacent ones of the plurality of combustors within the associated combustion chambers.

4. The system according to claim 1, wherein the combustion instability suppression system includes an exit member provided on the at least one pre-mixer, the exit member including a directional component that imparts an angle to the fuel-air mixture discharging into the combustion chamber, the angle of the fuel-air mixture creating the combustion asymmetry that suppresses combustion instability in the turbomachine.

5. The system according to claim 4, wherein the at least one pre-mixer includes a first pre-mixer having a first exit member including a first directional component and a second pre-mixer having a second exit member having a second directional component, the first directional component being positioned to direct the fuel-air mixture at a first angle and the second directional component being positioned to direct the fuel-air mixture at a second angle, the first angle being distinct from the second angle.

6. The system according to claim 1, wherein the at least one combustor includes a first combustor and a second combustor, the first and second combustors being fluidly connected by a conduit having a first end portion that is open to the first combustor and a second end portion that is open to the second combustor, the first combustor includes a first pre-mixer that discharges a first fuel-air mixture and the second combustor includes a second pre-mixer that discharges a second fuel-air mixture, the first pre-mixer being arranged at a first orientation relative to the first end portion of the conduit and the second pre-mixer being arranged at a second orientation relative to the second end portion of the conduit, the first orientation being distinct from the second orientation.

7. The system according to claim 1, wherein the combustion instability suppression system includes a cap member having at least one segment formed at a first angle, and at least one pre-mixer arranged at the at least one segment, the at least one pre-mixer including a first exit portion having a first longitudinal axis and a second exit portion having a second longitudinal axis, the first longitudinal axis being offset from the second longitudinal axis.

8. The system according to claim 7, wherein the first exit portion includes a first angled section.

9. The system according to claim 8, wherein the first angled section corresponds to the first angle.

10. The system according to claim 8, wherein the second exit portion includes a second angled section.

11. The system according to claim 10, wherein the first angled section is substantially similar to the second angled section.

12. The system according to claim 7, wherein the at least one segment of the cap member includes a first segment and a second segment, the first segment having a first angle and the second segment having a second angle, the second angle being distinct from the first angle.

13. The system according to claim 12, wherein the first segment includes a first pre-mixer and the second segment includes a second pre-mixer, the first pre-mixer including the first exit portion and the second exit portion, and the second pre-mixer including a third exit portion and a fourth exit portion.

14. The system according to claim 13, wherein the first exit portion includes a first angled section and the third exit portion includes a third angled section, the first angled section corresponding to the first angle and the third angled section corresponding to the second angle.

15. A method of suppressing combustion instability in a turbomachine comprising:
directing a fuel-air mixture through at least one pre-mixer into at least one combustor having a combustion chamber; and
forming a combustion asymmetry in the turbomachine, the combustion asymmetry suppressing combustion instability in the turbomachine.

16. The method of claim 15, wherein forming the combustion asymmetry in the turbomachine comprises forming the combustion asymmetry within the at least one combustor.

17. The method of claim 16, wherein forming the combustion asymmetry comprises passing the fuel-air mixture through an exit member having a directional component, the directional component imparting an angle to the fuel-air mixture relative to the pre-mixer.

18. The method of claim 16, further comprising:
directing a first fuel-air mixture through a first pre-mixer at a first angle into the combustion chamber; and
discharging a second fuel air mixture through a second pre-mixer at a second angle into the combustion chamber, the first angle being distinct from the second angle.

19. The method of claim 15, wherein directing the fuel-air mixture through at least one pre-mixer into at least one combustor comprises:
directing a first fuel-air mixture having a first configuration through a first pre-mixer associated with a first combustor, the first pre mixer being arranged at a first orientation relative to first end portion of a cross-fire tube; and
discharging a second fuel-air mixture having a second configuration through a second pre-mixer associated with a second combustor, the second pre-mixer being arranged at a second orientation relative to a second end portion of the cross-fire tube, the first orientation being distinct from the second orientation.

20. The method of claim 15, wherein forming the combustion asymmetry comprises directing a first portion of the fuel-air mixture through a first discharge portion of the at least one pre-mixer and a second portion of the fuel-air mixture through a second discharge portion of the at least one pre-mixer, the first discharge portion being longitudinally off-set from the second end portion.
